(19) United States
(12) Patent Application Publication
(10) Pub. No.: US 2024/0146639 A1
(43) Pub. Date: May 2, 2024

(54) METHODS AND APPARATUS TO REDUCE EMISSIONS IN GUIDED NETWORK ENVIRONMENTS

(71) Applicant: Intel Corporation, Santa Clara, CA (US)

(72) Inventors: Francesc Guim Bernat, Barcelona (ES); Manish Dave, Folsom, CA (US); Karthik Kumar, Chandler, AZ (US); Akhilesh S. Thyagaturu, Ruskin, FL (US); Matthew Henry Birkner, Las Vegas, NV (US); Adrian Hoban, Cratloe (IE)

(21) Appl. No.: 18/393,239

(22) Filed: Dec. 21, 2023

(51) Int. Cl. H04L 45/12; H04L 45/302

(52) U.S. Cl. CPC H04L 45/124; H04L 45/302

(57) ABSTRACT

Systems, apparatus, articles of manufacture, and methods are disclosed to reduce emissions in guided network environments. An apparatus includes interface circuitry, machine readable instructions, and programmable circuitry to at least one of instantiate or execute the machine readable instructions to collect data from respective network nodes corresponding to a request to access information, predict an emission of accessing the information via the respective network nodes using the data, and select a network path including at least one of the network nodes based on the predicted emission.

### FIELD OF THE DISCLOSURE

This disclosure relates generally to network routing and, more particularly, to methods and apparatus to reduce emissions in guided network environments.

### BACKGROUND

Network routing generally relates to a user (or a source) requesting data or information from an external device (e.g., a server) through a request. Accessing the information across a network can include routing the request through multiple network nodes connecting the user or source to a destination (e.g., the server). Energy is consumed at every network node since energy is required to consume the request and to either transfer the request to a new network node or to output an answer to the request.

### BRIEF DESCRIPTION OF THE DRAWINGS

FIG. 1 illustrates an example network path for accessing information.

FIG. 2 is a block diagram of an example environment in which an example guided network pathing circuitry operates to select a network path.

FIG. 3 is a block diagram of an example implementation of the guided network pathing circuitry of FIG. 2.

FIG. 4 is an example path selection chart.

FIG. 5 is an example node flow diagram of one of the network nodes of FIG. 1.

FIG. 6 is an example network path splitting diagram for splitting a request across multiple network nodes.

FIGS. 7-9 are flowcharts representative of example machine readable instructions and/or example operations that may be executed, instantiated, and/or performed by example programmable circuitry to implement the guided network pathing circuitry of FIG. 3.

FIG. 10 is a block diagram of an example processing platform including programmable circuitry structured to execute, instantiate, and/or perform the example machine readable instructions and/or perform the example operations of FIGS. 7-9 to implement the guided network pathing circuitry of FIG. 3.

FIG. 11 is a block diagram of an example implementation of the programmable circuitry of FIG. 10.

FIG. 12 is a block diagram of another example implementation of the programmable circuitry of FIG. 10.

FIG. 13 is a block diagram of an example software/firmware/instructions distribution platform (e.g., one or more servers) to distribute software, instructions, and/or firmware (e.g., corresponding to the example machine readable instructions of FIGS. 7-9) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Network routing can be used for a user or a source to access data or information from an external device or a server over a network. Examples include web browser searching, video streaming, accessing websites, or any other kind of data request via a network connection.

Network hops (e.g., connections between network nodes) can be either physical (e.g., top of the rack (TOR)) or virtual (e.g., virtual router). In both cases, energy and/or carbon usage may vary depending on multiple factors such as weather, network path utilization, network path efficiency, and an amount of renewable energy (e.g., solar energy, wind energy, etc.). These factors can impact emission-producing sources used to handle information access requests.

The network path chosen is usually dependent on the fastest (e.g., lowest latency) path to achieve the desired response. This allows for network paths to be chosen irrespective of emission impacts for accessing the information.

As internet usage continues to increase, and as more electronic devices become interdependent on network connectivity, network routing based on predicted emissions is becoming an increasingly important factor in reducing emissions across the world. Automating network path decision-making at large scale involves ingesting and comprehending vast amounts of distributed telemetry information related to carbon aware impacts to make decisions across thousands of network hops.

Therefore, there exists a need for a solution to guided network pathing that takes emissions, energy sources, telemetry data, etc. into account to select a network path that is both efficient and reduces emissions. Disclosed herein is an apparatus that implements a machine learning model to analyze data at network nodes to determine and select a network path to reduce emissions.

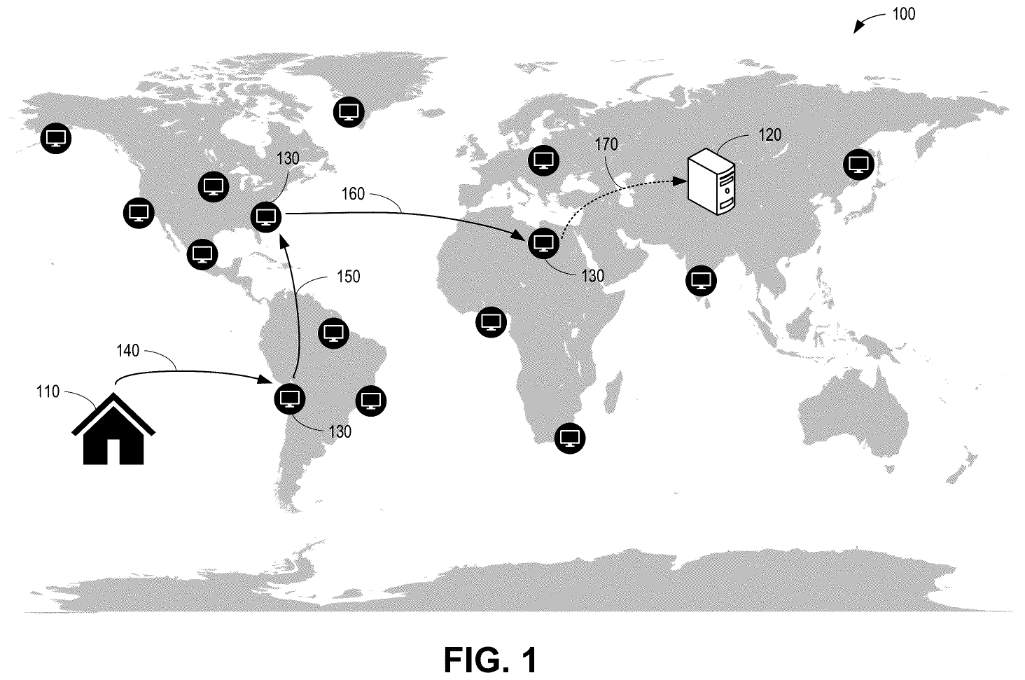

FIG. 1 illustrates an example environment 100 in which a source device 110 requests data from a destination device 120. In some examples, the source device 110 is a personal computer operated by a user submitting a search into a web browser. In other examples, the source device 110 generates a request to access the information from the destination 120.

In some examples, the destination 120 is a server, a database, or any other kind of data storage device. In examples provided herein, the destination 120 houses the information to which the source device 110 is requesting access.

A network node 130 is used as a connection point between the source device 110 and the destination 120. In examples provided herein, more than one network node 130 is distributed throughout the globe to connect the source device 110 to the destination 120. In some examples, more than one network node 130 is used for the source device 110 to access the information from the destination 120.

In operation, the destination 120 might not be in close proximity to the source device 110 (e.g., there may be a large distance between the source device 110 and the destination 120). In some examples, the data and/or the request can be vulnerable to cyber-attacks if not protected. Therefore, the network path may need to make multiple stops at network nodes 130 to ensure the information/request is protected and to ensure the information/request can be accessed within a reasonable timeframe (e.g., a reasonably low latency).

In the example of FIG. 1, a first network hop 140 connects the source device 110 to a respective one of the network nodes 130. In some examples, the first network hop 140 (or any subsequent network hop) is encrypted so as to protect the request from cyber-attacks. In other examples, the request is encrypted instead of the first network hop 140 (or any subsequent network hop). Thus, regardless of whether the request is encrypted, traveling from the source device 110 to the destination 120 over a single or a series of encrypted network hops ensures the request cannot be read and/or modified in transit.

A second network hop 150 and a third network hop 160 can also be used to shorten the distance between the hops and to also ensure the data/request is protected. In some examples, a fourth network hop 170 (e.g., a final network hop corresponding to the last hop between a last network node and the destination 120) is unencrypted to allow the destination 120 to process and answer the request from the source device 110.

In some examples, a response to the request is transmitted to the source device 110 via the same network path chosen to access the information. In other examples, a new analysis is performed to select a new network path for responding/transmitting data back to the source device 110.

Although the example of FIG. 1 shows four network hops, it should be understood that this is purely for illustrative purposes and that, in some examples, thousands of network hops across thousands of network nodes may be required to access the information from the destination 120.

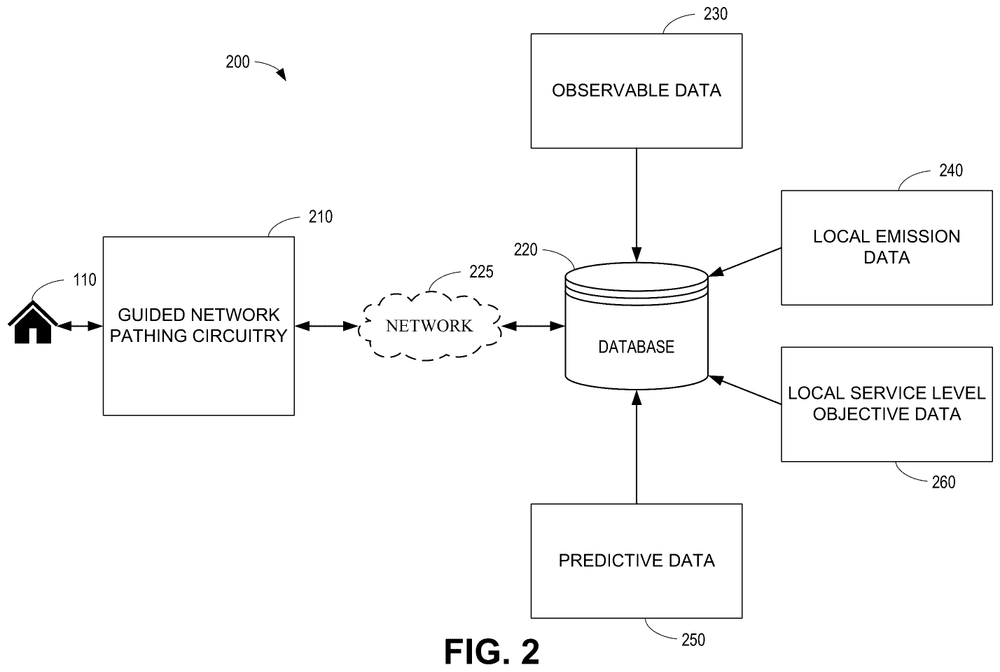

FIG. 2 is a block diagram of an example environment 200 in which example guided network pathing circuitry 210 of FIG. 1 operates to select a network path and train network nodes. The example environment 200 of FIG. 2 includes the source device 110 which communicates with the guided network pathing circuitry 210 via a direct connection, a wireless connection, etc.

The guided network pathing circuitry 210 communicates with a database 220. In some examples, the guided network pathing circuitry 210 communicates with the database 220 via a network 225. In other examples, the guided network pathing circuitry 210 communicates with the database 220 via a direct connection (e.g., directly connected to the database).

The database 220 stores information related to the network nodes 130 of FIG. 1. In examples disclosed herein, the database 220 includes information such as weather data corresponding to a location of the network node 130, amount of renewable energy sources available to power the network node 130, historic or predicted traffic data through the network node 130, etc.

In the example of FIG. 2, the database receives and/or stores observable data 230. The observable data 230 includes data that can be observed such as weather data, computing resources available at the network node 130, temperature conditions (e.g., ambient room temperature, platform temperature at the network node 130, etc.), or any other information that can be observed through sensors or telemetry analysis.

The database 220 of FIG. 2 also receives and/or stores local emission data 240 corresponding to emissions and/or carbon impacts at the network node 130. In some examples, the local emission data 240 includes how much emission is produced due to operation of the network node 130. In some examples, the local emission data 240 includes an amount and a type of power/energy source available (e.g., an amount of renewable energy sources, an amount of fossil fuel energy sources, etc.).

The database 220 of FIG. 2 further receives and/or stores predictive data 250 corresponding to anticipated operating levels of the network node 130. In some examples, the predictive data 250 includes anticipated traffic at the network node 130 due to an upcoming event (e.g., a sporting event or television broadcast). In some examples, the predictive data 250 includes cyclical data corresponding to common network traffic at the network node 130 (e.g., spikes in utilization at a certain time in the day).

The database 220 of FIG. 2 further receives and/or stores local service level objective (SLO) data 260. In some examples, the local SLO data 260 includes information corresponding to a threshold amount of emission for accessing information from the destination 120. In some examples, the threshold amount of emission originates via the source device 110 (e.g., generated by a computing device and/or requested by a user operating at the source device 110) defining a maximum amount of emissions that the request to access information should stay under. This allows the source device 110 to control and define how much emission is produced by the request to access information.

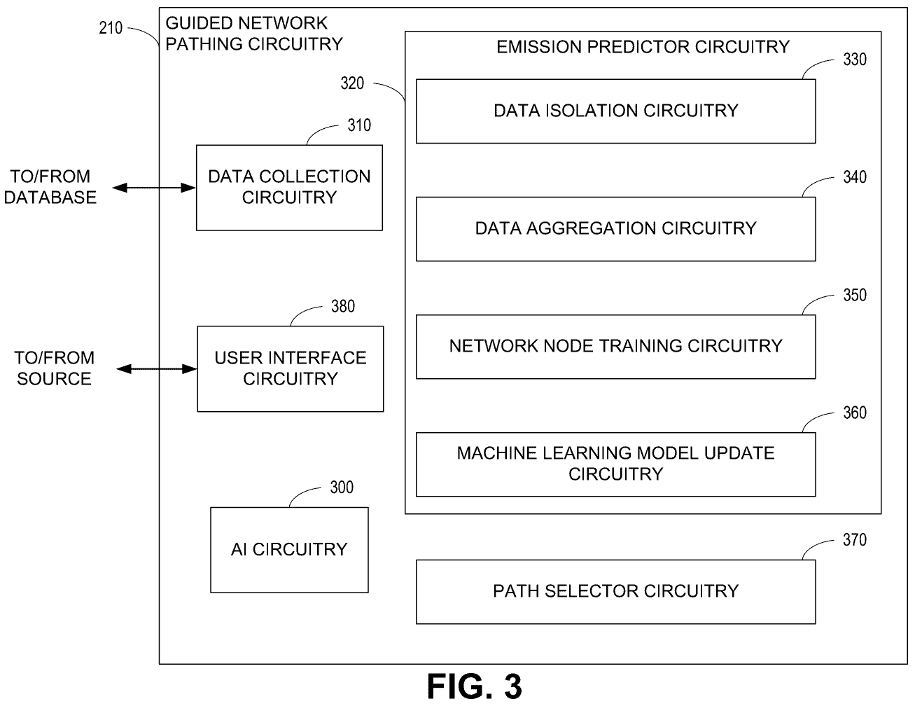

FIG. 3 is a block diagram of an example implementation of the guided network pathing circuitry 210 of FIG. 2 to identify and select a network path for accessing information from the destination 120. The guided network pathing circuitry 210 of FIG. 3 may be instantiated (e.g., creating an instance of, bring into being for any length of time, materialize, implement, etc.) by programmable circuitry such as a Central Processor Unit (CPU) executing first instructions. Additionally or alternatively, the guided network pathing circuitry 210 of FIG. 3 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 3 may, thus, be instantiated at the same or different times. Some or all of the circuitry of FIG. 3 may be instantiated, for example, in one or more threads executing concurrently on hardware and/or in series on hardware. Moreover, in some examples, some or all of the circuitry of FIG. 3 may be implemented by microprocessor circuitry executing instructions and/or FPGA circuitry performing operations to implement one or more virtual machines and/or containers.

The guided network pathing circuitry 210 of FIG. 3 includes an artificial intelligence (AI) circuitry 300, data collection circuitry 310, emission predictor circuitry 320, path selector circuitry 370, and user interface circuitry 380.

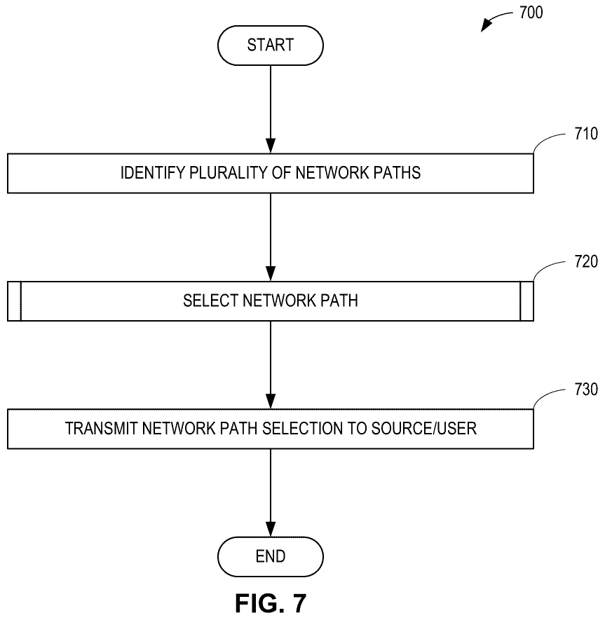

The AI circuitry 300 identifies network paths and deploys a machine learning model. In examples disclosed herein, the AI circuitry 300 operates at the network nodes 130. In some examples, the AI circuitry 300 identifies a pre-determined path that satisfies threshold(s) set by the source device 110. The machine learning model is deployed to reduce computational time and improve accuracy of emission predictions. In some examples, the AI circuitry 300 is instantiated by programmable circuitry executing network path identification and machine learning model deployment instructions and/or configured to perform operations such as those represented by the flowcharts of FIGS. 7 and/or 8.

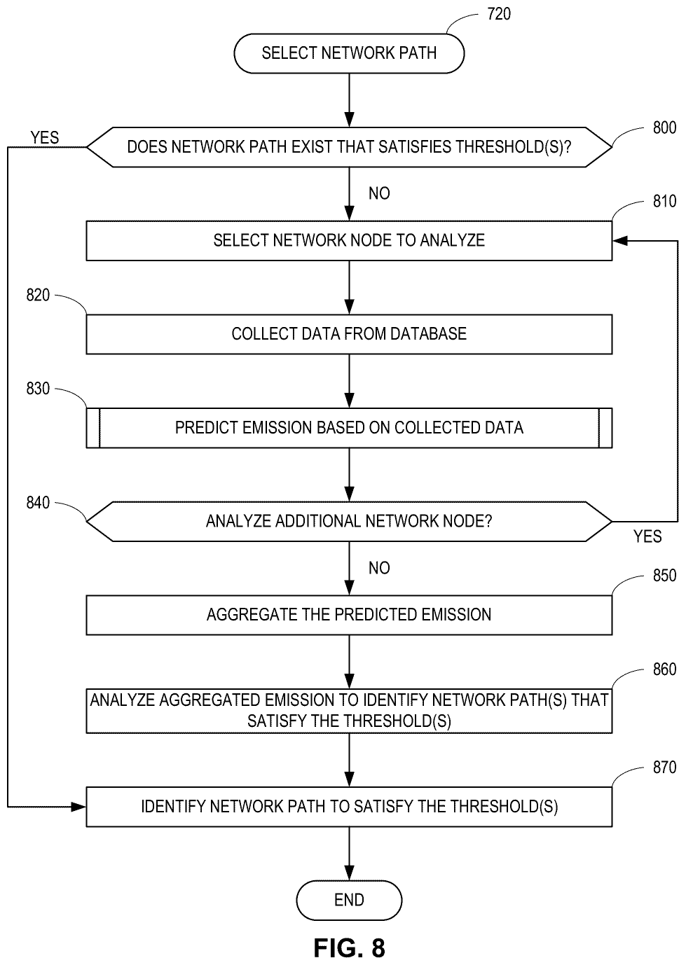

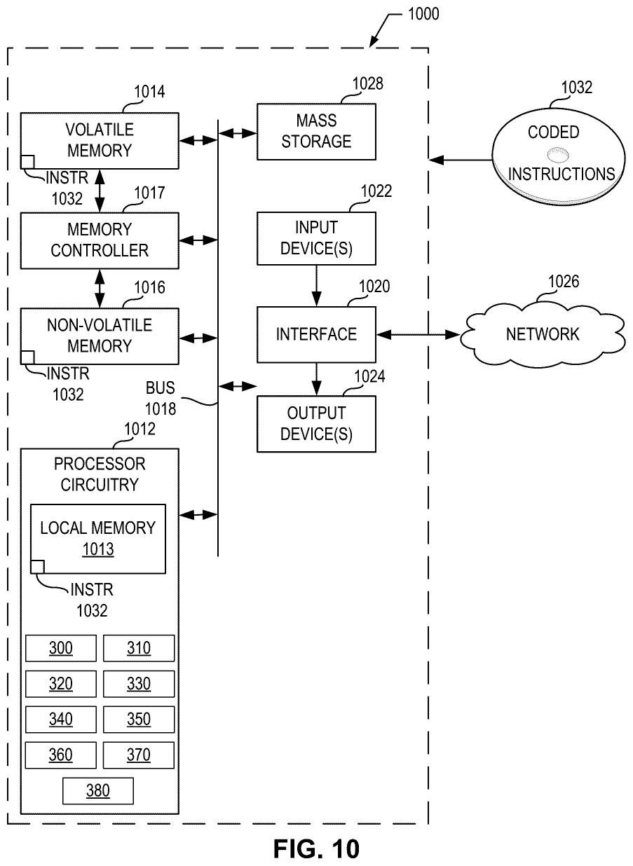

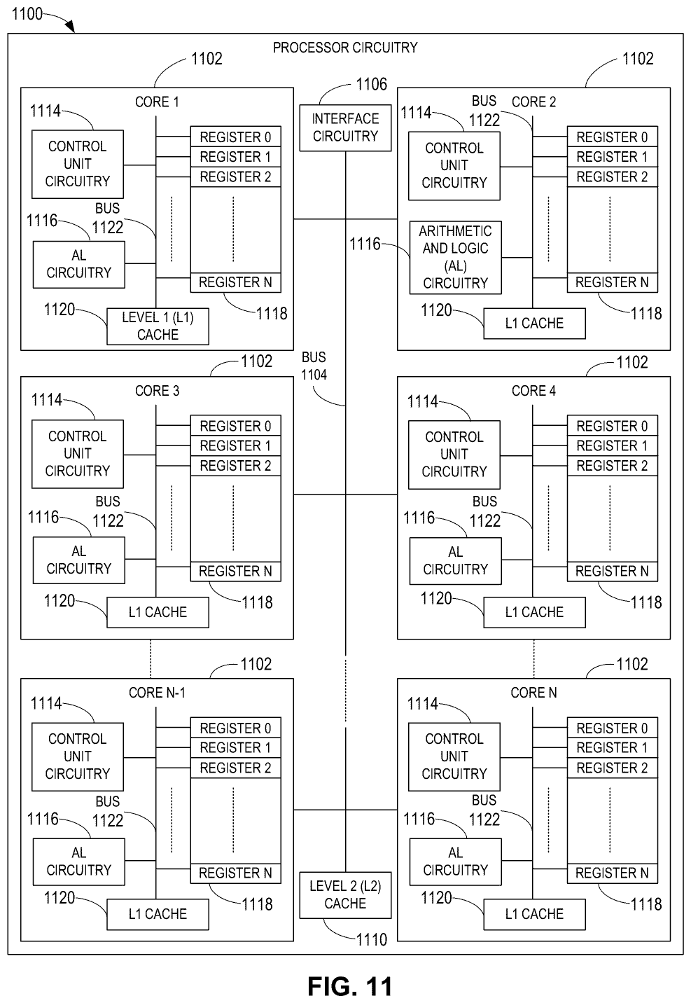

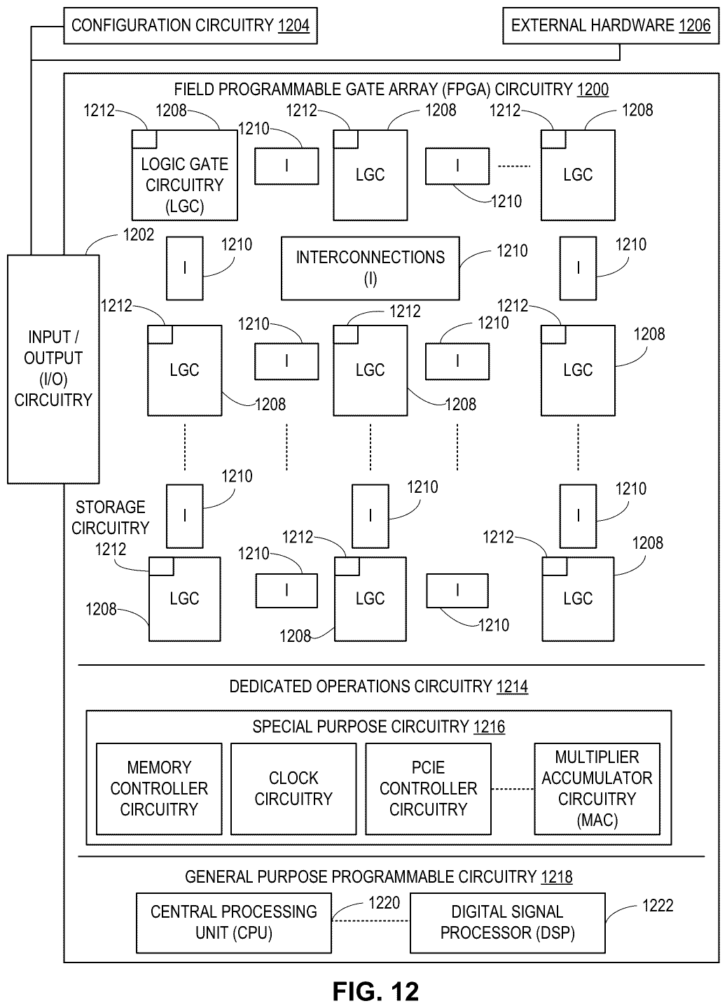

In some examples, the guided network pathing circuitry 210 includes means for identifying whether a pre-determined network path is present to satisfy emission threshold(s). For example, the means for identifying may be implemented by AI circuitry 300. In some examples, the AI circuitry 300 may be instantiated by programmable circuitry such as the example programmable circuitry 1012 of FIG. 10. For instance, the AI circuitry 300 may be instantiated by the example microprocessor 1100 of FIG. 11 executing machine executable instructions such as those implemented by at least block 710 of FIG. 7 and block 800 of FIG. 8. In some examples, the AI circuitry 300 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the AI circuitry 300 may be instantiated by any other combination of hardware, software, and/or firmware. For example, the AI circuitry 300 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The data collection circuitry 310 collects data from the network nodes 130 corresponding to a request to access information (e.g., accessing information from the destination 120). In some examples, the data collection circuitry 310 communicates with the database 220 to collect the data corresponding to the network nodes 130. In some examples, the data collection circuitry 310 communicated with the database 220 via the network 225 using a wired or direct connection (e.g., Ethernet) or a wireless connection. In some examples, the data collection circuitry 310 is instantiated by programmable circuitry executing data collection instructions and/or configured to perform operations such as those represented by the flowchart of FIG. 8.

In some examples, the guided network pathing circuitry 210 includes means for collecting data from the network nodes 130. For example, the means for collecting may be implemented by data collection circuitry 310. In some examples, the data collection circuitry 310 may be instantiated by programmable circuitry such as the example programmable circuitry 1012 of FIG. 10. For instance, the data collection circuitry 310 may be instantiated by the example microprocessor 1100 of FIG. 11 executing machine executable instructions such as those implemented by at least blocks 810, 820, and 840 of FIG. 8. In some examples, the data collection circuitry 310 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the data collection circuitry 310 may be instantiated by any other combination of hardware, software, and/or firmware. For example, the data collection circuitry 310 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The emission predictor circuitry 320 predicts emissions for network nodes 130 and predicts total emissions produced along a network path for accessing the information from the destination 120. In some examples, the machine learning model is used to predict the emissions based on data collected regarding the network node 130 and/or any of the factors listed in connection with FIG. 2 (e.g., predicted network traffic, observable data corresponding to weather, platform temperature, etc.).

The emission predictor circuitry 320 includes data isolation circuitry 330, data aggregation circuitry 340, network node training circuitry 350, and machine learning model update circuitry 360. In some examples, the emission predictor circuitry 320 is instantiated by programmable circuitry executing emission predictor instructions and/or configured to perform operations such as those represented by the flowcharts of FIGS. 8 and/or 9.

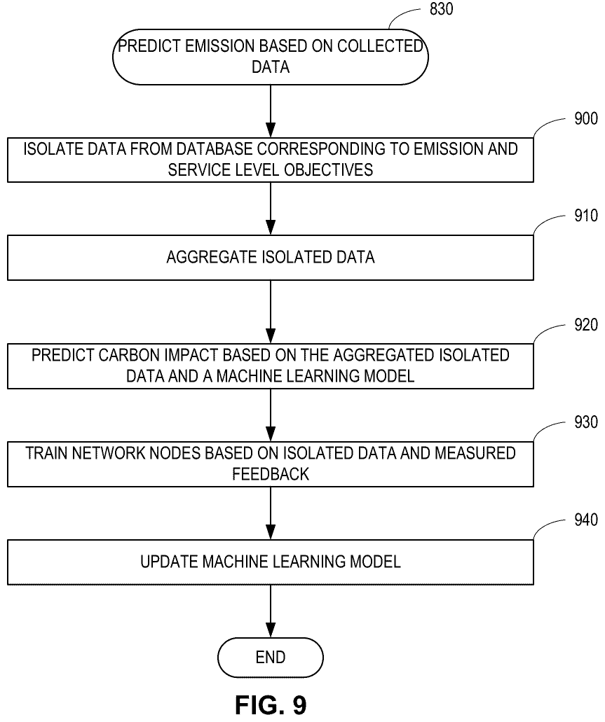

In some examples, the guided network pathing circuitry 210 includes means for predicting an emission of accessing information from the destination 120. For example, the means for predicting may be implemented by emission predictor circuitry 320. In some examples, the emission predictor circuitry 320 may be instantiated by programmable circuitry such as the example programmable circuitry 1012 of FIG. 10. For instance, the emission predictor circuitry 320 may be instantiated by the example microprocessor 1100 of FIG. 11 executing machine executable instructions such as those implemented by at least block 830 of FIG. 8 and block 920 of FIG. 9. In some examples, the emission predictor circuitry 320 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the emission predictor circuitry 320 may be instantiated by any other combination of hardware, software, and/or firmware. For example, the emission predictor circuitry 320 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The data isolation circuitry 330 isolates data corresponding to emission data and service level objectives (SLOs) from the data collected by the data collection circuitry 310. In some examples, the data collected may include data not pertinent to predicting carbon emissions. In such an example, isolating pertinent information from the collected information can reduce computation time. In some examples, the data isolation circuitry 330 is instantiated by programmable circuitry executing data isolation instructions and/or configured to perform operations such as those represented by the flowchart of FIG. 9.

In some examples, the guided network pathing circuitry 210 includes means for isolating information corresponding to emission data and SLOs. For example, the means for isolating may be implemented by data isolation circuitry 330. In some examples, the data isolation circuitry 330 may be instantiated by programmable circuitry such as the example programmable circuitry 1012 of FIG. 10. For instance, the data isolation circuitry 330 may be instantiated by the example microprocessor 1100 of FIG. 11 executing machine executable instructions such as those implemented by at least block 900 of FIG. 9. In some examples, the data isolation circuitry 330 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the data isolation circuitry 330 may be instantiated by any other combination of hardware, software, and/or firmware. For example, the data isolation circuitry 330 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The data aggregation circuitry 340 aggregates the emission data and SLOs from the network node 130 being analyzed. In some examples, an aggregation function is applied to the emission data and SLOs to weigh some data (e.g., amount of green energy available) higher than other data (e.g., physical location of the network node 130). In such an example, certain data contributes to a higher emission prediction than other data. In some examples, the data aggregation circuitry 340 is instantiated by programmable circuitry executing data aggregation instructions and/or configured to perform operations such as those represented by the flowchart of FIG. 9.

In some examples, the guided network pathing circuitry 210 includes means for aggregating emission data and SLOs for a network node 130. For example, the means for aggregating may be implemented by data aggregation circuitry 340. In some examples, the data aggregation circuitry 340 may be instantiated by programmable circuitry such as the example programmable circuitry 1012 of FIG. 10. For instance, the data aggregation circuitry 340 may be instantiated by the example microprocessor 1100 of FIG. 11 executing machine executable instructions such as those implemented by at least block 910 of FIG. 9. In some examples, the data aggregation circuitry 340 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the data aggregation circuitry 340 may be instantiated by any other combination of hardware, software, and/or firmware. For example, the data aggregation circuitry 340 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The network node training circuitry 350 trains the network node 130 based on the predicted emissions and feedback generated by the machine learning model. In some examples, training the network node 130 includes using a training algorithm (e.g., supervised or unsupervised, federated learning, etc.) to teach the network node 130 based on updated parameters such as amount of green energy available or predicted emission based on operating the network node 130. In some examples, the network node training circuitry 350 is instantiated by programmable circuitry executing network node training instructions and/or configured to perform operations such as those represented by the flowchart of FIG. 9.

In some examples, the guided network pathing circuitry 210 includes means for training a network node 130 based on the predicted emission. For example, the means for training may be implemented by network node training circuitry 350. In some examples, the network node training circuitry 350 may be instantiated by programmable circuitry such as the example programmable circuitry 1012 of FIG. 10. For instance, the network node training circuitry 350 may be instantiated by the example microprocessor 1100 of FIG. 11 executing machine executable instructions such as those implemented by at least block 930 of FIG. 9. In some examples, the network node training circuitry 350 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the network node training circuitry 350 may be instantiated by any other combination of hardware, software, and/or firmware. For example, the network node training circuitry 350 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The machine learning model update circuitry 360 updates the machine learning model based on the predicted emission, the selection of the network path, and/or the trained network node(s) 130. In some examples, the machine learning model update circuitry 360 is instantiated by programmable circuitry executing machine learning model update instructions and/or configured to perform operations such as those represented by the flowchart of FIG. 9.

In some examples, the guided network pathing circuitry 210 includes means for updating a machine learning model. For example, the means for updating may be implemented by machine learning model update circuitry 360. In some examples, the machine learning model update circuitry 360 may be instantiated by programmable circuitry such as the example programmable circuitry 1012 of FIG. 10. For instance, the machine learning model update circuitry 360 may be instantiated by the example microprocessor 1100 of FIG. 11 executing machine executable instructions such as those implemented by at least block 940 of FIG. 9. In some examples, the machine learning model update circuitry 360 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the machine learning model update circuitry 360 may be instantiated by any other combination of hardware, software, and/or firmware. For example, the machine learning model update circuitry 360 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The path selector circuitry 370 selects the network path for accessing the information from the destination 120. In some examples, the path selector circuitry 370 is instantiated by programmable circuitry executing path selection instructions and/or configured to perform operations such as those represented by the flowchart of FIG. 8.

In some examples, the guided network pathing circuitry 210 includes means for selecting a network path based on the predicted emission. For example, the means for selecting may be implemented by path selector circuitry 370. In some examples, the path selector circuitry 370 may be instantiated by programmable circuitry such as the example programmable circuitry 1012 of FIG. 10. For instance, the path selector circuitry 370 may be instantiated by the example microprocessor 1100 of FIG. 11 executing machine executable instructions such as those implemented by at least block 720 of FIG. 7 and blocks 850, 860, and 870 of FIG. 8. In some examples, the path selector circuitry 370 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the path selector circuitry 370 may be instantiated by any other combination of hardware, software, and/or firmware. For example, the path selector circuitry 370 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The user interface circuitry 380 causes transmission of the selected network path and all associated information to the source device 110 or a user. In some examples, the user interface circuitry 380 transmits/causes transmission of the predicted emission for accessing the information, the latency in accessing the information, and/or any other information such as network hops (e.g., location of network nodes 130 used). In some examples, the user interface circuitry 380 is instantiated by programmable circuitry executing user interface instructions and/or configured to perform operations such as those represented by the flowchart of FIG. 7.

In some examples, the guided network pathing circuitry 210 includes means for transmitting the selected network path to the source device 110 or a user. For example, the means for transmitting may be implemented by user interface circuitry 380. In some examples, the user interface circuitry 380 may be instantiated by programmable circuitry such as the example programmable circuitry 1012 of FIG. 10. For instance, the user interface circuitry 380 may be instantiated by the example microprocessor 1100 of FIG. 11 executing machine executable instructions such as those implemented by at least block 730 of FIG. 7. In some examples, the user interface circuitry 380 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the user interface circuitry 380 may be instantiated by any other combination of hardware, software, and/or firmware. For example, the user interface circuitry 380 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the guided network pathing circuitry 210 of FIG. 2 is illustrated in FIG. 3, one or more of the elements, processes, and/or devices illustrated in FIG. 3 may be combined, divided, re-arranged, omitted, eliminated, and/or implemented in any other way. Further, the example AI circuitry 300, example data collection circuitry 310, example emission predictor circuitry 320, example data isolation circuitry 330, example data aggregation circuitry 340, example network node training circuitry 350, example machine learning model update circuitry 360, example path selector circuitry 370, example user interface circuitry 380, and/or, more generally, the example guided network pathing circuitry 210 of FIG. 3, may be implemented by hardware alone or by hardware in combination with software and/or firmware. Thus, for example, any of the example AI circuitry 300, example data collection circuitry 310, example emission predictor circuitry 320, example data isolation circuitry 330, example data aggregation circuitry 340, example network node training circuitry 350, example machine learning model update circuitry 360, example path selector circuitry 370, example user interface circuitry 380, and/or, more generally, the example guided network pathing circuitry 210, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example guided network pathing circuitry 210 of FIG. 3 may include one or more elements, processes, and/or devices in addition to, or instead of, those illustrated in FIG. 3, and/or may include more than one of any or all of the illustrated elements, processes and devices.

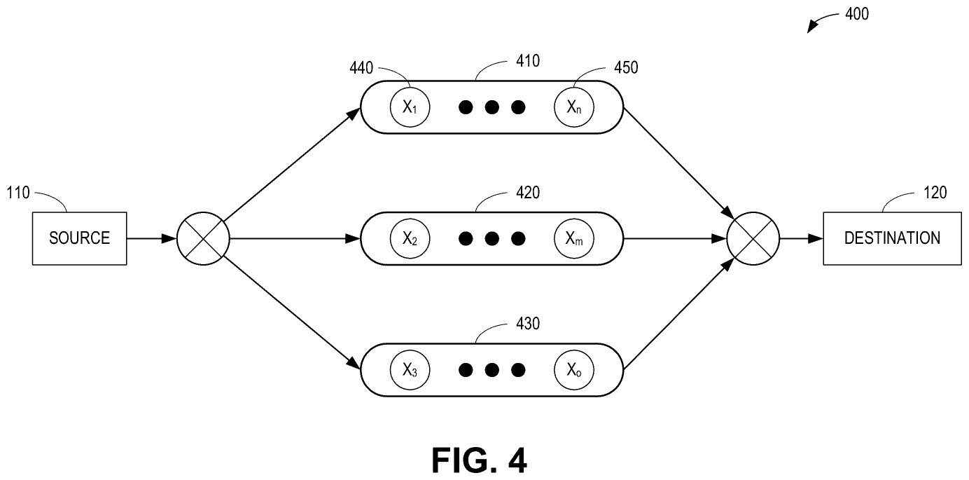

FIG. 4 is an example path selection chart 400. The example path selection chart 400 includes the source device 110 accessing information from the destination 120.

As illustrated in the example of FIG. 4, a request is sent from the source device 110, and a network path is selected to access the information from the destination 120. The example of FIG. 4 includes a first network path 410, a second network path 420, and a third network path 430.

Each of the first, second, and third network paths 410, 420, 430 includes network hops to access the information from the destination 120. In the example of FIG. 4, the first network path 410 includes a first network hop 440 and a final network hop 450. The first network hop 440 is representative of the first network node used to select the network path for accessing the information from the destination 120. The final network hop 450 is representative of the last or final network node used to access the information from the destination 120. In some examples, the number of network nodes 130 between the first network hop 440 and the final network hop 450 is variable based on the analysis of the data within the database 220.

The second and third network paths 420, 430 also include the first network hop 440 and the final network hop 450. In some examples, the first network hop 440 and/or the final network hop 450 for all possible network paths is the same. In other examples, the first network hop 440 and the final network hop 450 is different and variable based on analyzing potential network paths.

The first, second, and third network paths 410, 420, 430 can have differing performance characteristics. For example, the first network path 410 may include more network hops (e.g., more than a thousand network hops) but utilize more renewable energy sources (e.g., solar power, wind power, etc.). In such an example, a latency in accessing the information from the destination 120 may be greater due to the greater amount of network hops, but an amount of emission may be lower since fewer fossil fuels are used.

For example, if a network path were to use all renewable energy sources, the amount of emission generated corresponding to the request to access the information from the destination 120 may be between 0.04-0.16 grams of carbon dioxide (CO₂) (based on retrieving one gigabyte of information from the destination 120). By contrast, if a network path were to use all fossil energy sources, the amount of emission generated by the same request may be around 3.2 grams of CO₂. Therefore, reducing fossil energy sources reduces emission by selecting network paths utilizing more renewable energy sources.

In another example, the second network path 420 may have fewer network hops but utilize more fossil fuels and/or utilize more power intensive network nodes (e.g., high traffic network nodes requiring more power to operate). In such an example, the second network path 420 may have lower latency but higher amounts of emission.

In yet another example, the third network path 430 may have significantly more network hops but may ultimately have lower latency since the network nodes 130 used are not heavily trafficked. In such an example, in addition to analyzing energy sources and additional emission data, the third network path 430 may ultimately achieve a desired approach of lowering emissions while still maintaining relatively low latency.

In some examples, there may be more than three network paths to choose from, and the guided network pathing circuitry 210 of FIG. 2 may collect information from all potential network paths and determine the appropriate network path based on the observable data 230, the local emission data 240, the predictive data 250, and/or the local SLO data 260.

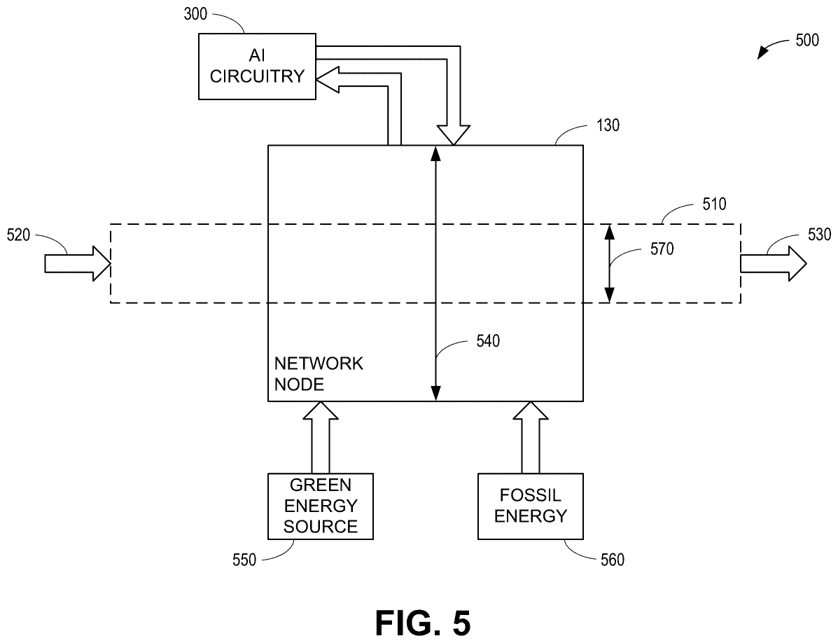

FIG. 5 is an example node flow diagram 500 of one of the network nodes 130 of FIG. 1. In the example of FIG. 5, a data plane 510 flows through the network node 130. The data plane 510 represents an amount of processing resources required of the network node 130 to process the request to access information. The data plane 510 includes an ingress point 520 representing an input of the request to access information (e.g., processing the request to access information) and an egress point 530 representing an output of the request to access information (e.g., routing the request to the destination 120).

The network node 130 includes a processing capacity 540. In examples disclosed herein, the processing capacity includes an amount of computational resources and/or an amount of energy capacity of the network node 130 to process requests to access information. In the example of FIG. 5, the network node 130 includes a green energy source 550 (e.g., solar, wind, etc.) and a fossil energy source 560 (e.g., coal, fossil fuels, etc.).

In the example of FIG. 5, the network node 130 receives at least a first portion of its total energy/electricity from the green energy source 550 and a second portion of its total energy/electricity from the fossil energy source 560. The first portion and the second portion add up to 100% of the total energy/electricity to operate the network node 130. In some examples, the fossil energy source 560 may not be present to operate the network node 130. In such an example, the second portion would equal 0% and the first portion would equal 100%.

The AI circuitry 300 of FIG. 3 communicates with the network node 130 to inform the network node 130 of energy recommendations from the source device 110. In some examples, the AI circuitry 300 includes a maximum amount of energy to be spent on the request, a maximum amount of the fossil energy source 560 to be used on the request, etc. In some examples, the energy recommendations are variable and can change with changing conditions within the network node 130 or due to other factors such as a reduction in traffic at the network node 130, weather conditions at the network node (e.g., more sun results in higher efficiency in solar energy), or any other singular or combination of factors disclosed herein.

In the example of FIG. 5, a processing consumption 570 represents the total amount of energy and processing resources used to accommodate the request to access the information. In some examples, the processing consumption 570 follows the energy recommendations provided by the AI circuitry 300. In some examples, the processing consumption 570 is variable based on the factors disclosed herein.

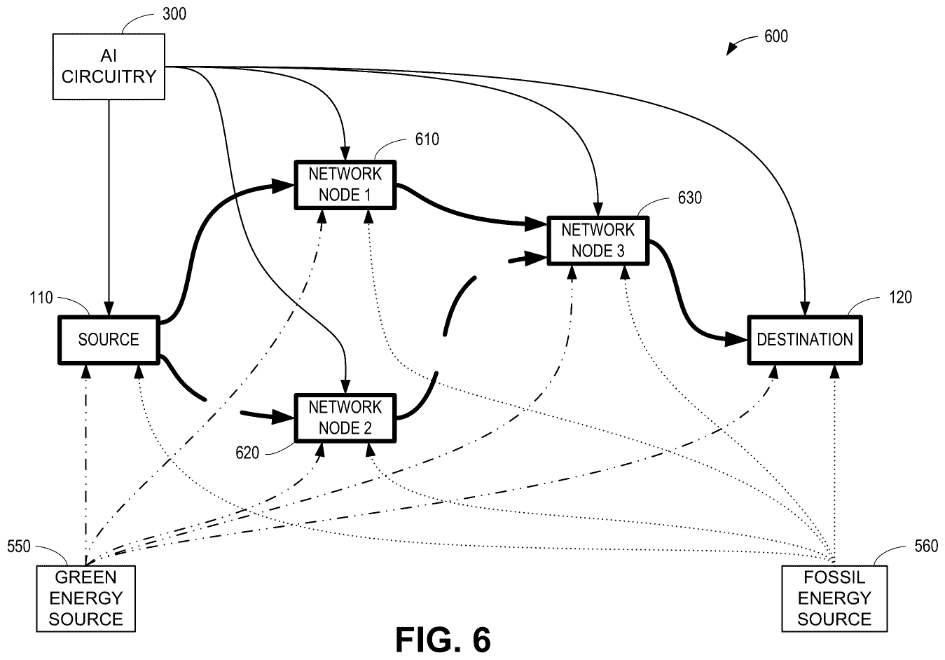

FIG. 6 is an example network path splitting diagram 600 for splitting a request across multiple network nodes. As shown in the example of FIG. 6, the source device 110 is requesting data from the destination 120. As disclosed herein, the AI circuitry 300 operates at the source device 110, the destination 120, and at every network node. The source device 110, the destination 120, and the network nodes are operated at least in part by the green energy source 550 and/or the fossil energy source 560.

In the example of FIG. 6, the source device 110 splits the request to access information across a first network node 610 and a second network node 620. For illustrative purposes, assume that the request equals 100% of a request to access information. In this example, the request can be split into portions of the request anywhere between 0% and 100%. In the example of FIG. 6, the request is split into a first portion (represented by the line connecting the source device 110 to the first network node 610) equal to 60% and a second portion (represented by the line connecting the source device 110 to the second network node 620) equal to 40%. The first network node 610 receives the first portion and the second network node 620 receives the second portion. It should be understood that the first and second network nodes 610, 620 can receive different percentages of the request based on factors such as network bandwidth availability, a data size of the request (e.g., amount of megabytes), etc.

It may be desirable to split the request if the guided network pathing circuitry 210 determines that it can be split to meet the emission threshold, latency requirements, etc. It also may be desirable to split the request based on computing resources and/or predicted traffic at a particular network node.

In the example of FIG. 6, the first network node 610 and the second network node 620 send their portions of the request, 60% and 40% respectively, to a third network node 630. The third network node 630 combines the respective portions and continues processing 100% of the request. The third network node 630 then routes the request to the destination 120.

It should be understood that more than two network nodes 130 can be used to split a request and the split request can propagate for more than a single level of network nodes 130 (e.g., the 40% split can be fed into a fourth network node before combining with the third network node 630). The example of FIG. 6 is just for illustrative purposes.

Flowchart(s) representative of example machine readable instructions, which may be executed by programmable circuitry to implement and/or instantiate the guided network pathing circuitry 210 of FIG. 3 and/or representative of example operations which may be performed by programmable circuitry to implement and/or instantiate the guided network pathing circuitry 210 of FIG. 3, are shown in FIGS. 7-9. The machine readable instructions may be one or more executable programs or portion(s) of one or more executable programs for execution by programmable circuitry such as the programmable circuitry 1012 shown in the example processor platform 1000 discussed below in connection with FIG. 10 and/or may be one or more function(s) or portion(s) of functions to be performed by the example programmable circuitry (e.g., an FPGA) discussed below in connection with FIGS. 11 and/or 12. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 7-9, many other methods of implementing the example guided network pathing circuitry 210 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 7-9 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 7 is a flowchart representative of example machine readable instructions and/or example operations 700 that may be executed, instantiated, and/or performed by programmable circuitry to identify and select a network path. The example machine-readable instructions and/or the example operations 700 of FIG. 7 begin at block 710, at which the AI circuitry 300 identifies a plurality of network paths. In some examples, the plurality of network paths includes all potential routes that can be taken to access the information from the destination 120. In some examples, the plurality of network paths identified by the AI circuitry 300 may exclude network paths that have too many network hops, produce too much emissions, have relatively high latency, etc. In such an example, the plurality of network paths identified includes network paths that statistically, over a period of time, fall within emission thresholds and SLOs defined by the source device 110.

Once the AI circuitry 300 identifies the plurality of network paths, the guided network pathing circuitry 210 selects a network path from the plurality of network paths. (Block 720). In some examples, the guided network pathing circuitry 210 collects data from the database 220 corresponding to information regarding the network nodes 130 along the plurality of network paths.

Once the guided network pathing circuitry 210 selects the network path, the user interface circuitry 380 causes transmission of the selected network path to the source device 110 or the user. (Block 730). In some examples, the causing the transmission of the selected network path allows the source device 110 or the user to determine whether the selected network path is acceptable (e.g., meets emission thresholds and other SLOs). This allows the source device 110 or the user to modify the request if appropriate to potentially achieve lower emissions.

FIG. 8 is a flowchart representative of example machine readable instructions and/or example operations that may be executed, instantiated, and/or performed by programmable circuitry to select the network path from the plurality of network paths identified. The example machine-readable instructions and/or the example operations of FIG. 8 begin at block 800, at which the AI circuitry 300 determines whether a network path exists that satisfies threshold(s) defined by the source device 110. In some examples, the threshold(s) include latency, maximum emissions, amount/percentage of renewable energy to process the request, etc. In examples disclosed herein, the AI circuitry 300, through training the network nodes 130 and updating a machine learning model, can pre-select a network path exhibiting the performance necessary to meet the threshold(s). This reduced computation time and latency in selecting a network path.

If the AI circuitry 300 determines that a network path does not exist that satisfies the threshold(s) (e.g., block 800 returns a result of NO), the data collection circuitry 310 selects a network node (e.g., the network node 130) to analyze. (Block 810). In some examples, the data collection circuitry 310 sequentially selects the network node 130 to analyze (e.g., starting with the closest network node 130 to the source device 110). In other examples, the data collection circuitry 310 selects the network node 130 that is predicted to exhibit a largest amount of emissions and/or energy consumption.

Once the data collection circuitry 310 selects the network node 130 to analyze, the data collection circuitry 310 collects data from the database 220 corresponding to the network node 130 selected. (Block 820). In some examples, the data corresponds to at least one of the observable data 230, the local emission data 240, the predictive data 250, and/or the local SLO data 260. In some examples, the data collection circuitry 310 collects the data from the database 220 via the network 225.

Once the data collection circuitry 310 collects the data from the database 220, the emission predictor circuitry 320 predicts an amount of emission for requesting the data through the selected network node 130. (Block 830). In some examples, the emission is predicted based on an analysis of the data collected from the database 220. In some examples, the predicted emission is an amount of carbon dioxide (CO₂) released into the atmosphere (e.g., weight of CO₂ in tons).

Once the emission predictor circuitry 320 predicts an amount of emission, the data collection circuitry 310 determines whether additional network nodes 130 are to be analyzed. (Block 840). In some examples, each network node 130 along the identified network paths are to be analyzed and then aggregated to determine a total predicted amount of emission.

If the data collection circuitry 310 determines that additional network nodes 130 are to be analyzed (e.g., block 840 returns a result of YES), then the operations of block 810 through 840 are repeated until no additional network nodes 130 are remaining to be analyzed.

If the data collection circuitry 310 determines that no additional network nodes 130 are to be analyzed (e.g., block 840 returns a result of NO), then the path selector circuitry 370 aggregates the predicted emission from each network node 130. (Block 850). In some examples, each identified network path is isolated and the predicted emissions from each network node 130 along the isolated network paths is aggregated. The aggregated predicted emission is the predicted amount of emission for accessing the information from the destination 120.

Once the path selector circuitry 370 aggregates the predicted emissions, the path selector circuitry 370 analyzes the aggregated emission values across the isolated network paths. (Block 860). In some examples, the analyzing of the aggregated emission values includes determining which network path satisfies the threshold(s) defined by the source device 110. In some examples, more than one network path may satisfy the threshold(s). In some examples, determining whether the network path satisfied the threshold(s) includes comparing the predicted emission to the threshold(s).

If the AI circuitry 300 determines that a network path exists to satisfy the threshold(s) (e.g., block 800 returns a result of YES) or when the path selector circuitry identifies the network path(s), the path selector circuitry 370 identifies the network path for accessing the information from the destination 120. (Block 870). In some examples, where more than one network path is available to satisfy the threshold(s), the path selector circuitry 370 selects the network path with the lowest latency. In other examples, the path selector circuitry 370 selects the network path with the lowest predicted emission.

FIG. 9 is a flowchart representative of example machine readable instructions and/or example operations that may be executed, instantiated, and/or performed by programmable circuitry to predict emissions. The example machine-readable instructions and/or the example operations of FIG. 9 begin at block 900, at which the data isolation circuitry 330 isolates the collected data from the database 220 corresponding to emission and SLOs. In some examples, the data from the database 220 may include data that may not be pertinent to emissions. Therefore, the data corresponding to emissions and SLOs may need to be isolated prior to analyzing.

Once the data isolation circuitry 330 isolates the data, the data aggregation circuitry 340 aggregates the isolated data corresponding to emissions and SLOs. (Block 910). In some examples, the aggregation of the isolated data includes applying a weight function to the data. In such an example, certain data (such as amount of renewable energy sources available, energy consumption required, etc.) may be weighted higher than other data (such as the geographic location of the network node 130).

Once the data aggregation circuitry 340 aggregated the isolated data, the emission predictor circuitry 320 predicts the emissions based on the aggregated data and a machine learning model. (Block 920). In some examples, the machine learning model implements a learning function (e.g., supervised learning or unsupervised learning) to predict the emissions based on the data from the database 220 and/or a generated feedback from previous iterations of the machine learning model. In some examples, the machine learning model is applied across the network path amongst all network nodes 130.

Once the emission predictor circuitry 320 predicts the emissions, the network node training circuitry 350 trains the network node 130 based on the predicted emissions. (Block 930). In some examples, training the network node 130 includes decreasing the processing consumption 570 at the network node 130, identifying cyclical network utilization associated with the network node 130 (e.g., sporting events, holidays, etc.), etc.

Once the network node training circuitry 350 trains the network node 130, the machine learning model update circuitry 360 updates the machine learning model based on the predicted emissions and the trained network node 130. (Block 940). In some examples, the machine learning model is updated based on the trained network node 130 to produce more accurate emission predictions at the network node 130. In such an example, training the network node 130 to reduce the amount of fossil fuel used to operate the network node 130 reduces the amount of emissions generated by the network node 130. Such a reduction would necessarily indicate that the machine learning model could predict lower emissions from the network node 130 on future iterations. In some examples, the machine learning model is deployed via the AI circuitry 300.

FIG. 10 is a block diagram of an example programmable circuitry platform 1000 structured to execute and/or instantiate the example machine-readable instructions and/or the example operations of FIGS. 7-9 to implement the guided network pathing circuitry 210 of FIG. 3. The programmable circuitry platform 1000 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1000 of the illustrated example includes programmable circuitry 1012. The programmable circuitry 1012 of the illustrated example is hardware. For example, the programmable circuitry 1012 can be implemented by one or more integrated circuits, logic circuits, FPGAs, microprocessors, CPUs, GPUs, DSPs, and/or microcontrollers from any desired family or manufacturer. The programmable circuitry 1012 may be implemented by one or more semiconductor based (e.g., silicon based) devices. In this example, the programmable circuitry 1012 implements AI circuitry 300, data collection circuitry 310, emission predictor circuitry 320 data isolation circuitry 330, data aggregation circuitry 340, network node training circuitry 350, machine learning model update circuitry 360, path selector circuitry 370, and user interface circuitry 380.

The programmable circuitry 1012 of the illustrated example includes a local memory 1013 (e.g., a cache, registers, etc.). The programmable circuitry 1012 of the illustrated example is in communication with main memory 1014, 1016, which includes a volatile memory 1014 and a non-volatile memory 1016, by a bus 1018. The volatile memory 1014 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1016 may be implemented by flash memory and/or any other desired type of memory device. Access to the main memory 1014, 1016 of the illustrated example is controlled by a memory controller 1017. In some examples, the memory controller 1017 may be implemented by one or more integrated circuits, logic circuits, microcontrollers from any desired family or manufacturer, or any other type of circuitry to manage the flow of data going to and from the main memory 1014, 1016.

The programmable circuitry platform 1000 of the illustrated example also includes interface circuitry 1020. The interface circuitry 1020 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1022 are connected to the interface circuitry 1020. The input device(s) 1022 permit(s) a user (e.g., a human user, a machine user, etc.) to enter data and/or commands into the programmable circuitry 1012. The input device(s) 1022 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1024 are also connected to the interface circuitry 1020 of the illustrated example. The output device(s) 1024 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1020 of the illustrated example, thus, typically includes a graphics driver card, a graphics driver chip, and/or graphics processor circuitry such as a GPU.

The interface circuitry 1020 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1026. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1000 of the illustrated example also includes one or more mass storage discs or devices 1028 to store firmware, software, and/or data. Examples of such mass storage discs or devices 1028 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1032, which may be implemented by the machine readable instructions of FIGS. 7-9, may be stored in the mass storage device 1028, in the volatile memory 1014, in the non-volatile memory 1016, and/or on at least one non-transitory computer readable storage medium such as a CD or DVD which may be removable.

FIG. 11 is a block diagram of an example implementation of the programmable circuitry 1012 of FIG. 10. In this example, the programmable circuitry 1012 of FIG. 10 is implemented by a microprocessor 1100. For example, the microprocessor 1100 may be a general-purpose microprocessor (e.g., general-purpose microprocessor circuitry). The microprocessor 1100 executes some or all of the machine-readable instructions of the flowcharts of FIGS. 7-9 to effectively instantiate the circuitry of FIG. 3 as logic circuits to perform operations corresponding to those machine readable instructions. In some such examples, the circuitry of FIG. 3 is instantiated by the hardware circuits of the microprocessor 1100 in combination with the machine-readable instructions. For example, the microprocessor 1100 may be implemented by multi-core hardware circuitry such as a CPU, a DSP, a GPU, an XPU, etc. Although it may include any number of example cores 1102 (e.g., 1 core), the microprocessor 1100 of this example is a multi-core semiconductor device including N cores. The cores 1102 of the microprocessor 1100 may operate independently or may cooperate to execute machine readable instructions. For example, machine code corresponding to a firmware program, an embedded software program, or a software program may be executed by one of the cores 1102 or may be executed by multiple ones of the cores 1102 at the same or different times. In some examples, the machine code corresponding to the firmware program, the embedded software program, or the software program is split into threads and executed in parallel by two or more of the cores 1102. The software program may correspond to a portion or all of the machine readable instructions and/or operations represented by the flowcharts of FIGS. 7-9.

The cores 1102 may communicate by a first example bus 1104. In some examples, the first bus 1104 may be implemented by a communication bus to effectuate communication associated with one(s) of the cores 1102. For example, the first bus 1104 may be implemented by at least one of an Inter-Integrated Circuit (I2C) bus, a Serial Peripheral Interface (SPI) bus, a PCI bus, or a PCIe bus. Additionally or alternatively, the first bus 1104 may be implemented by any other type of computing or electrical bus. The cores 1102 may obtain data, instructions, and/or signals from one or more external devices by example interface circuitry 1106. The cores 1102 may output data, instructions, and/or signals to the one or more external devices by the interface circuitry 1106. Although the cores 1102 of this example include example local memory 1120 (e.g., Level 1 (L1) cache that may be split into an L1 data cache and an L1 instruction cache), the microprocessor 1100 also includes example shared memory 1110 that may be shared by the cores (e.g., Level 2 (L2 cache)) for high-speed access to data and/or instructions. Data and/or instructions may be transferred (e.g., shared) by writing to and/or reading from the shared memory 1110. The local memory 1120 of each of the cores 1102 and the shared memory 1110 may be part of a hierarchy of storage devices including multiple levels of cache memory and the main memory (e.g., the main memory 1014, 1016 of FIG. 10). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1102 may be referred to as a CPU, DSP, GPU, etc., or any other type of hardware circuitry. Each core 1102 includes control unit circuitry 1114, arithmetic and logic (AL) circuitry (sometimes referred to as an ALU) 1116, a plurality of registers 1118, the local memory 1120, and a second example bus 1122. Other structures may be present. For example, each core 1102 may include vector unit circuitry, single instruction multiple data (SIMD) unit circuitry, load/store unit (LSU) circuitry, branch/jump unit circuitry, floating-point unit (FPU) circuitry, etc. The control unit circuitry 1114 includes semiconductor-based circuits structured to control (e.g., coordinate) data movement within the corresponding core 1102. The AL circuitry 1116 includes semiconductor-based circuits structured to perform one or more mathematic and/or logic operations on the data within the corresponding core 1102. The AL circuitry 1116 of some examples performs integer based operations. In other examples, the AL circuitry 1116 also performs floating-point operations. In yet other examples, the AL circuitry 1116 may include first AL circuitry that performs integer-based operations and second AL circuitry that performs floating-point operations. In some examples, the AL circuitry 1116 may be referred to as an Arithmetic Logic Unit (ALU).

The registers 1118 are semiconductor-based structures to store data and/or instructions such as results of one or more of the operations performed by the AL circuitry 1116 of the corresponding core 1102. For example, the registers 1118 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1118 may be arranged in a bank as shown in FIG. 11. Alternatively, the registers 1118 may be organized in any other arrangement, format, or structure, such as by being distributed throughout the core 1102 to shorten access time. The second bus 1122 may be implemented by at least one of an I2C bus, a SPI bus, a PCI bus, or a PCIe bus.

Each core 1102 and/or, more generally, the microprocessor 1100 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1100 is a semiconductor device fabricated to include many transistors interconnected to implement the structures described above in one or more integrated circuits (ICs) contained in one or more packages.

The microprocessor 1100 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1100, in the same chip package as the microprocessor 1100 and/or in one or more separate packages from the microprocessor 1100.

FIG. 12 is a block diagram of another example implementation of the programmable circuitry 1012 of FIG. 10. In this example, the programmable circuitry 1012 is implemented by FPGA circuitry 1200. For example, the FPGA circuitry 1200 may be implemented by an FPGA. The FPGA circuitry 1200 can be used, for example, to perform operations that could otherwise be performed by the example microprocessor 1100 of FIG. 11 executing corresponding machine readable instructions. However, once configured, the FPGA circuitry 1200 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1100 of FIG. 11 described above (which is a general purpose device that may be programmed to execute some or all of the machine readable instructions represented by the flowchart(s) of FIGS. 7-9 but whose interconnections and logic circuitry are fixed once fabricated), the FPGA circuitry 1200 of the example of FIG. 12 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 7-9. In particular, the FPGA circuitry 1200 may be thought of as an array of logic gates, interconnections, and switches. The switches can be programmed to change how the logic gates are interconnected by the interconnections, effectively forming one or more dedicated logic circuits (unless and until the FPGA circuitry 1200 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 7-9. As such, the FPGA circuitry 1200 may be configured and/or structured to effectively instantiate some or all of the operations/functions corresponding to the machine readable instructions of the flowchart(s) of FIGS. 7-9 as dedicated logic circuits to perform the operations/functions corresponding to those software instructions in a dedicated manner analogous to an ASIC. Therefore, the FPGA circuitry 1200 may perform the operations/functions corresponding to the some or all of the machine readable instructions of FIGS. 7-9 faster than the general-purpose microprocessor can execute the same.

In the example of FIG. 12, the FPGA circuitry 1200 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1200 of FIG. 12 may access and/or load the binary file to cause the FPGA circuitry 1200 of FIG. 12 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1200 of FIG. 12 to cause configuration and/or structuring of the FPGA circuitry 1200 of FIG. 12, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1200 of FIG. 12 may access and/or load the binary file to cause the FPGA circuitry 1200 of FIG. 12 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1200 of FIG. 12 to cause configuration and/or structuring of the FPGA circuitry 1200 of FIG. 12, or portion(s) thereof.

The FPGA circuitry 1200 of FIG. 12, includes example input/output (I/O) circuitry 1202 to obtain and/or output data to/from example configuration circuitry 1204 and/or external hardware 1206. For example, the configuration circuitry 1204 may be implemented by interface circuitry that may obtain a binary file, which may be implemented by a bit stream, data, and/or machine-readable instructions, to configure the FPGA circuitry 1200, or portion(s) thereof. In some such examples, the configuration circuitry 1204 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1206 may be implemented by external hardware circuitry. For example, the external hardware 1206 may be implemented by the microprocessor 1100 of FIG. 11.

The FPGA circuitry 1200 also includes an array of example logic gate circuitry 1208, a plurality of example configurable interconnections 1210, and example storage circuitry 1212. The logic gate circuitry 1208 and the configurable interconnections 1210 are configurable to instantiate one or more operations/functions that may correspond to at least some of the machine readable instructions of FIGS. 7-9 and/or other desired operations. The logic gate circuitry 1208 shown in FIG. 12 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1208 to enable configuration of the electrical structures and/or the logic gates to form circuits to perform desired operations/functions. The logic gate circuitry 1208 may include other electrical structures such as look-up tables (LUTs), registers (e.g., flip-flops or latches), multiplexers, etc.

The configurable interconnections 1210 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1208 to program desired logic circuits.

The storage circuitry 1212 of the illustrated example is structured to store result(s) of the one or more of the operations performed by corresponding logic gates. The storage circuitry 1212 may be implemented by registers or the like. In the illustrated example, the storage circuitry 1212 is distributed amongst the logic gate circuitry 1208 to facilitate access and increase execution speed.

The example FPGA circuitry 1200 of FIG. 12 also includes example dedicated operations circuitry 1214. In this example, the dedicated operations circuitry 1214 includes special purpose circuitry 1216 that may be invoked to implement commonly used functions to avoid the need to program those functions in the field. Examples of such special purpose circuitry 1216 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1200 may also include example general purpose programmable circuitry 1218 such as an example CPU 1220 and/or an example DSP 1222. Other general purpose programmable circuitry 1218 may additionally or alternatively be present such as a GPU, an XPU, etc., that can be programmed to perform other operations.

Although FIGS. 11 and 12 illustrate two example implementations of the programmable circuitry 1012 of FIG. 10, many other approaches are contemplated. For example, FPGA circuitry may include an on-board CPU, such as one or more of the example CPU 1220 of FIG. 11. Therefore, the programmable circuitry 1012 of FIG. 10 may additionally be implemented by combining at least the example microprocessor 1100 of FIG. 11 and the example FPGA circuitry 1200 of FIG. 12. In some such hybrid examples, one or more cores 1102 of FIG. 11 may execute a first portion of the machine readable instructions represented by the flowchart(s) of FIGS. 7-9 to perform first operation(s)/function(s), the FPGA circuitry 1200 of FIG. 12 may be configured and/or structured to perform second operation(s)/function(s) corresponding to a second portion of the machine readable instructions represented by the flowcharts of FIG. 7-9, and/or an ASIC may be configured and/or structured to perform third operation(s)/function(s) corresponding to a third portion of the machine readable instructions represented by the flowcharts of FIGS. 7-9.

It should be understood that some or all of the circuitry of FIG. 3 may, thus, be instantiated at the same or different times. For example, same and/or different portion(s) of the microprocessor 1100 of FIG. 11 may be programmed to execute portion(s) of machine-readable instructions at the same and/or different times. In some examples, same and/or different portion(s) of the FPGA circuitry 1200 of FIG. 12 may be configured and/or structured to perform operations/functions corresponding to portion(s) of machine-readable instructions at the same and/or different times.

In some examples, some or all of the circuitry of FIG. 3 may be instantiated, for example, in one or more threads executing concurrently and/or in series. For example, the microprocessor 1100 of FIG. 11 may execute machine readable instructions in one or more threads executing concurrently and/or in series. In some examples, the FPGA circuitry 1200 of FIG. 12 may be configured and/or structured to carry out operations/functions concurrently and/or in series. Moreover, in some examples, some or all of the circuitry of FIG. 3 may be implemented within one or more virtual machines and/or containers executing on the microprocessor 1100 of FIG. 11.

In some examples, the programmable circuitry 1012 of FIG. 10 may be in one or more packages. For example, the microprocessor 1100 of FIG. 11 and/or the FPGA circuitry 1200 of FIG. 12 may be in one or more packages. In some examples, an XPU may be implemented by the programmable circuitry 1012 of FIG. 10, which may be in one or more packages. For example, the XPU may include a CPU (e.g., the microprocessor 1100 of FIG. 11, the CPU 1220 of FIG. 12, etc.) in one package, a DSP (e.g., the DSP 1222 of FIG. 12) in another package, a GPU in yet another package, and an FPGA (e.g., the FPGA circuitry 1200 of FIG. 12) in still yet another package.

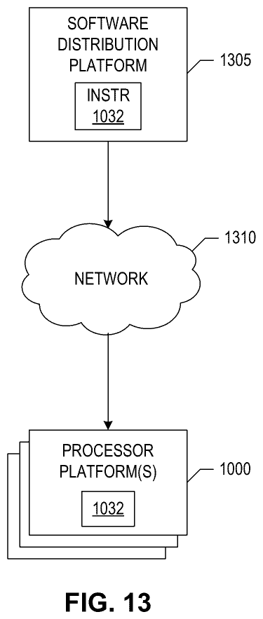

A block diagram illustrating an example software distribution platform 1305 to distribute software such as the example machine readable instructions 1032 of FIG. 10 to other hardware devices (e.g., hardware devices owned and/or operated by third parties from the owner and/or operator of the software distribution platform) is illustrated in FIG. 13. The example software distribution platform 1305 may be implemented by any computer server, data facility, cloud service, etc., capable of storing and transmitting software to other computing devices. The third parties may be customers of the entity owning and/or operating the software distribution platform 1305. For example, the entity that owns and/or operates the software distribution platform 1305 may be a developer, a seller, and/or a licensor of software such as the example machine readable instructions 1032 of FIG. 10. The third parties may be consumers, users, retailers, OEMs, etc., who purchase and/or license the software for use and/or re-sale and/or sub-licensing. In the illustrated example, the software distribution platform 1305 includes one or more servers and one or more storage devices. The storage devices store the machine readable instructions 1032, which may correspond to the example machine readable instructions of FIGS. 7-9, as described above. The one or more servers of the example software distribution platform 1305 are in communication with an example network 1310, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1032 from the software distribution platform 1305. For example, the software, which may correspond to the example machine readable instructions of FIG. 7-9, may be downloaded to the example programmable circuitry platform 1000, which is to execute the machine readable instructions 1032 to implement the guided network pathing circuitry 210. In some examples, one or more servers of the software distribution platform 1305 periodically offer, transmit, and/or force updates to the software (e.g., the example machine readable instructions 1032 of FIG. 10) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

From the foregoing, it will be appreciated that example systems, apparatus, articles of manufacture, and methods have been disclosed that reduce emissions in guided network environments. Disclosed systems, apparatus, articles of manufacture, and methods improve the efficiency of using a computing device by accessing sensor data, telemetry data, observable data, predictive data, and service level objectives at each network node along a network path to predict emissions at the network nodes and selecting a network path based on the emission prediction. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to reduce emissions in guided network environments are disclosed herein. Further examples and combinations thereof include the following:

Example 1 includes an apparatus comprising interface circuitry, machine readable instructions, and programmable circuitry to at least one of instantiate or execute the machine readable instructions to collect data from respective network nodes corresponding to a request to access information, predict an emission of accessing the information via the respective network nodes using the data, and select a network path including at least one of the network nodes based on the predicted emission.

Example 2 includes the apparatus of example 1, wherein the data includes local emission data corresponding to an emission of accessing the information via the respective network nodes.

Example 3 includes the apparatus of example 1 or 2, wherein the data includes at least one of energy output via green energy sources, energy output via fossil fuel energy sources, and energy requirements to satisfy the request to access the information.

Example 4 includes the apparatus of any of examples 1-3, wherein the data includes observable data corresponding to computing resources at the respective network nodes, predictive data corresponding to anticipated traffic at the respective network nodes, and local service level objectives corresponding to an emission threshold.

Example 5 includes the apparatus of any of examples 1-4, wherein the programmable circuitry is to select the network path based on a comparison of the predicted emission to an emission threshold.

Example 6 includes the apparatus of example 5, wherein the programmable circuitry is to determine whether a pre-determined network path is present to satisfy the emission threshold, and select the pre-determined network path when the pre-determined network path is present.

Example 7 includes the apparatus of any of examples 1-6, wherein the programmable circuitry is to train the respective network nodes based on the data and a generated feedback from selecting the network path.

Example 8 includes the apparatus of example 7, wherein the programmable circuitry is to update a machine learning model based on selecting the network path and training the respective network nodes.

Example 9 includes the apparatus of any of examples 1-8, wherein the programmable circuitry is to cause transmission of the selected network path to facilitate at least one of an acceptance or a modification of the request to access the information.

Example 10 includes a non-transitory machine readable storage medium comprising instructions to cause programmable circuitry to at least collect data from respective network nodes corresponding to a request to access information, predict an emission of accessing the information via the respective network nodes using the data, and select a network path including at least one of the network nodes based on the predicted emission.

Example 11 includes the non-transitory machine readable storage medium of example 10, wherein the data includes local emission data corresponding to an emission of accessing the information via the respective network nodes.

Example 12 includes the non-transitory machine readable storage medium of example 10 or 11, wherein the data includes at least one of energy output via green energy sources, energy output via fossil fuel energy sources, and energy requirements to satisfy the request to access the information.

Example 13 includes the non-transitory machine readable storage medium of any of examples 10-12, wherein the data includes observable data corresponding to computing resources at the respective network nodes, predictive data corresponding to anticipated traffic at the respective network nodes, and local service level objectives corresponding to an emission threshold.

Example 14 includes the non-transitory machine readable storage medium of any of examples 10-13, wherein the instructions cause the programmable circuitry to select the network path based on a comparison of the predicted emission to an emission threshold.

Example 15 includes the non-transitory machine readable storage medium of example 14, wherein the instructions cause the programmable circuitry to determine whether a pre-determined network path is present to satisfy the emission threshold, and select the pre-determined network path when the pre-determined network path is present.

Example 16 includes the non-transitory machine readable storage medium of any of examples 10-15, wherein the instructions cause the programmable circuitry to train the respective network nodes based on the data and a generated feedback from selecting the network path.

Example 17 includes the non-transitory machine readable storage medium of example 16, wherein the programmable circuitry is to update a machine learning model based on selecting the network path and training the respective network nodes.

Example 18 includes the non-transitory machine readable storage medium of any of examples 10-17, wherein the instructions cause the programmable circuitry to cause transmission of the selected network path to facilitate at least one of an acceptance or a modification of the request to access the information.

Example 19 includes a method comprising collecting data from respective network nodes corresponding to a request to access information, predicting an emission of accessing the information via the respective network nodes using the data, and selecting a network path including at least one of the network nodes based on the predicted emission.

Example 20 includes the method of example 19, wherein the data includes local emission data corresponding to an emission of accessing the information via the respective network nodes.

Example 21 includes the method of example 19 or 20, wherein the data includes at least one of energy output via green energy sources, energy output via fossil fuel energy sources, and energy requirements to satisfy the request to access the information.

Example 22 includes the method of any of examples 19-21, wherein the data includes observable data corresponding to computing resources at the respective network nodes, predictive data corresponding to anticipated traffic at the respective network nodes, and local service level objectives corresponding to an emission threshold.

Example 23 includes the method of any of examples 19-22, further including selecting the network path based on a comparison of the predicted emission to an emission threshold.

Example 24 includes the method of example 23, further including determining whether a pre-determined network path is present to satisfy the emission threshold, and selecting the pre-determined network path when the pre-determined network path is present.

Example 25 includes the method of any of examples 19-24, further including training the respective network nodes based on the data and a generated feedback from selecting the network path.

Example 26 includes the method of example 25, further including updating a machine learning model based on selecting the network path and training the respective network nodes.

Example 27 includes the method of any of examples 19-26, further including causing transmission of the selected network path to facilitate at least one of an acceptance or a modification of the request to access the information.

Example 28 includes an apparatus comprising means for collecting data from respective network nodes corresponding to a request to access information, means for predicting an emission of accessing the information via the respective network nodes using the data, and means for selecting a network path including at least one of the network nodes based on the predicted emission.

Example 29 includes the apparatus of example 28, wherein the data includes local emission data corresponding to an emission of accessing the information via the respective network nodes.

Example 30 includes the apparatus of example 28 or 29, wherein the data includes at least one of energy output via green energy sources, energy output via fossil fuel energy sources, and energy requirements to satisfy the request to access the information.

Example 31 includes the apparatus of any of examples 28-30, wherein the data includes observable data corresponding to computing resources at the respective network nodes, predictive data corresponding to anticipated traffic at the respective network nodes, and local service level objectives corresponding to an emission threshold.

Example 32 includes the apparatus of any of examples 28-31, wherein the means for selecting is to select the network path based on a comparison of the predicted emission to an emission threshold.

Example 33 includes the apparatus of example 32, further including means for identifying whether a pre-determined network path is present to satisfy the emission threshold, wherein the means for selecting is to select the pre-determined network path when the pre-determined network path is present.

Example 34 includes the apparatus of any of examples 28-33, further including means for training the respective network nodes based on the data and a generated feedback from selecting the network path.

Example 35 includes the apparatus of example 34, further including means for updating a machine learning model based on selecting the network path and training the respective network nodes.

Example 36 includes the apparatus of any of examples 28-35, further including means for transmitting the selected network path to facilitate at least one of an acceptance or a modification of the request to access the information.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1. An apparatus comprising:
interface circuitry;
machine readable instructions; and
programmable circuitry to at least one of instantiate or execute the machine readable instructions to:
collect data from respective network nodes corresponding to a request to access information;
predict an emission of accessing the information via the respective network nodes using the data; and
select a network path including at least one of the network nodes based on the predicted emission.

2. The apparatus of claim 1, wherein the data includes local emission data corresponding to an emission of accessing the information via the respective network nodes.

3. The apparatus of claim 1, wherein the data includes at least one of energy output via green energy sources, energy output via fossil fuel energy sources, and energy requirements to satisfy the request to access the information.

4. The apparatus of claim 1, wherein the data includes:
observable data corresponding to computing resources at the respective network nodes;
predictive data corresponding to anticipated traffic at the respective network nodes; and
local service level objectives corresponding to an emission threshold.

5. The apparatus of claim 1, wherein the programmable circuitry is to select the network path based on a comparison of the predicted emission to an emission threshold.

6. The apparatus of claim 5, wherein the programmable circuitry is to:
determine whether a pre-determined network path is present to satisfy the emission threshold; and
select the pre-determined network path when the pre-determined network path is present.

7. The apparatus of claim 1, wherein the programmable circuitry is to train the respective network nodes based on the data and a generated feedback from selecting the network path.

8. The apparatus of claim 7, wherein the programmable circuitry is to update a machine learning model based on selecting the network path and training the respective network nodes.

9. The apparatus of claim 1, wherein the programmable circuitry is to cause transmission of the selected network path to facilitate at least one of an acceptance or a modification of the request to access the information.

10. A non-transitory machine readable storage medium comprising instructions to cause programmable circuitry to at least:
collect data from respective network nodes corresponding to a request to access information;
predict an emission of accessing the information via the respective network nodes using the data; and
select a network path including at least one of the network nodes based on the predicted emission.

11. The non-transitory machine readable storage medium of claim 10, wherein the data includes local emission data corresponding to an emission of accessing the information via the respective network nodes.

12. The non-transitory machine readable storage medium of claim 10, wherein the data includes at least one of energy output via green energy sources, energy output via fossil fuel energy sources, and energy requirements to satisfy the request to access the information.

13. The non-transitory machine readable storage medium of claim 10, wherein the data includes:
observable data corresponding to computing resources at the respective network nodes;
predictive data corresponding to anticipated traffic at the respective network nodes; and
local service level objectives corresponding to an emission threshold.

14. The non-transitory machine readable storage medium of claim 10, wherein the instructions cause the programmable circuitry to select the network path based on a comparison of the predicted emission to an emission threshold.

15. The non-transitory machine readable storage medium of claim 14, wherein the instructions cause the programmable circuitry to:
determine whether a pre-determined network path is present to satisfy the emission threshold; and
select the pre-determined network path when the pre-determined network path is present.

16. The non-transitory machine readable storage medium of claim 10, wherein the instructions cause the programmable circuitry to train the respective network nodes based on the data and a generated feedback from selecting the network path.

17. The non-transitory machine readable storage medium of claim 16, wherein the programmable circuitry is to update a machine learning model based on selecting the network path and training the respective network nodes.

18. The non-transitory machine readable storage medium of claim 10, wherein the instructions cause the programmable circuitry to cause transmission of the selected network path to facilitate at least one of an acceptance or a modification of the request to access the information.

19. A method comprising:
collecting data from respective network nodes corresponding to a request to access information;
predicting an emission of accessing the information via the respective network nodes using the data; and
selecting a network path including at least one of the network nodes based on the predicted emission.

20. The method of claim 19, wherein the data includes local emission data corresponding to an emission of accessing the information via the respective network nodes.

21-36. (canceled)
